(19) United States
(12) Patent Application Publication
(10) Pub. No.: US 2026/0277150 A1
(43) Pub. Date: Sep. 17, 2026

(54) IMAGE FORMING APPARATUS

(71) Applicant: CANON KABUSHIKI KAISHA, Tokyo (JP)

(72) Inventor: DAI KANAI, Chiba (JP)

(21) Appl. No.: 19/558,909

(22) Filed: Mar. 6, 2026

(30) Foreign Application Priority Data
Mar. 14, 2025 (JP) 2025-041797

(51) Int. Cl. G03G 21/16; G03G 15/00; G03G 15/01

(52) U.S. Cl. CPC G03G 21/1619; G03G 15/80; G03G 15/0189

(57) ABSTRACT

An image forming apparatus includes first and second frame bodies disposed adjacent to each other, an image forming member disposed on the first frame body, a driving unit disposed on the first frame body and configured to drive the image forming member, a power supply unit disposed on the second frame body, and a conduction connection portion configured to electrically connect the image forming member and the power supply unit. The conduction connection portion includes a first member disposed on the first frame body and including a first contact that is connected to the image forming member, the first member extending toward a side of the power supply unit, and a second member including a second contact that is electrically connected to the first member, the second member being configured to electrically connect the power supply unit and the first member.

### BACKGROUND

### FIELD OF THE TECHNOLOGY

This disclosure relates to an image forming apparatus such as a printer, a copier, a facsimile, or a multifunction printer.

### DESCRIPTION OF THE RELATED ART

Hitherto, an image forming apparatus is proposed in which a plurality of modules, which are each preconfigured according to their functions with a large number of components, are prepared in advance, and a flexible product configuration is enabled by appropriately combining these modules in accordance with product specifications (see Japanese Patent Laid-Open No. 2021-103245). In each module, components are mounted with respect to frames so that inter-component precision is ensured within the frame, and the image forming apparatus is constructed by stacking and connecting such modules.

An image forming apparatus can be broadly divided into multiple functional blocks, for example, such as an image forming block that forms an image on a recording material, a supply block that feeds the recording material to the image forming blocks, and a discharge block that discharges the recording material to the outside after image formation. These image forming block, supply block, and discharge block include various units that achieve various functions, and, recently, these units are respectively disposed in a plurality of separable frame bodies formed by combining numerous support struts and sheet metals.

For example, in the image forming block, image forming units, which form toner images on photosensitive drums, and drive units, which provide a driving force to the image forming units, are disposed on the same frame body. In addition, power supply units that supply power to the image forming units are also disposed on the same frame body. However, hitherto, in order to secure space for disposing both the drive units and the power supply units on the same frame body on which the image forming units are disposed, there are cases where this leads to an increase in the size of the frame body.

### SUMMARY

According to a first aspect of the present disclosure, an image forming apparatus configured to form an image on a recording material is provided. The image forming apparatus includes a first frame body, a second frame body disposed adjacent to the first frame body, an image forming member disposed on the first frame body, a driving unit disposed on the first frame body and configured to drive the image forming member, a power supply unit disposed on the second frame body and configured to supply power to the image forming member, and a conduction connection portion configured to electrically connect the image forming member and the power supply unit. The conduction connection portion includes a first member disposed on the first frame body and including a first contact that is connected to the image forming member, the first member extending toward a side of the power supply unit, and a second member including a second contact that is electrically connected to the first member, the second member being configured to electrically connect the power supply unit and the first member.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration of an image forming apparatus.

FIG. 2 is a schematic diagram illustrating a separation configuration of the image forming apparatus.

FIG. 3 is a perspective view illustrating a discharge block, an image forming block, and a supply block.

FIG. 4 is a perspective view illustrating a process cartridge.

FIG. 5 is a perspective view illustrating a portion of a front surface of an image forming rear plate.

FIG. 6 is a perspective view illustrating a conduction connection portion according to a first embodiment.

FIG. 7 is a diagram for illustrating an electrical connection using the conduction connection portion according to the first embodiment.

FIG. 8 is a perspective view illustrating a connected state of the image forming block and the supply block according to a second embodiment.

FIG. 9 is a perspective view illustrating a conduction connection portion according to the second embodiment.

FIG. 10 is a diagram for illustrating an electrical connection using the conduction connection portion according to the second embodiment.

FIG. 11 is a perspective view illustrating an unconnected state of the image forming block and the supply block according to a third embodiment.

FIG. 12 is a perspective view illustrating a connected state of the image forming block and the supply block according to the third embodiment.

FIG. 13 is a perspective view illustrating a conduction connection portion according to the third embodiment.

FIG. 14 is a diagram for illustrating an electrical connection using the conduction connection portion according to the third embodiment.

FIG. 15 is a diagram for illustrating an electrical connection using a conduction connection portion according to a fourth embodiment.

FIG. 16 is a schematic diagram illustrating a separation configuration of an image forming apparatus of another embodiment.

### DESCRIPTION OF THE EMBODIMENTS

### First Embodiment

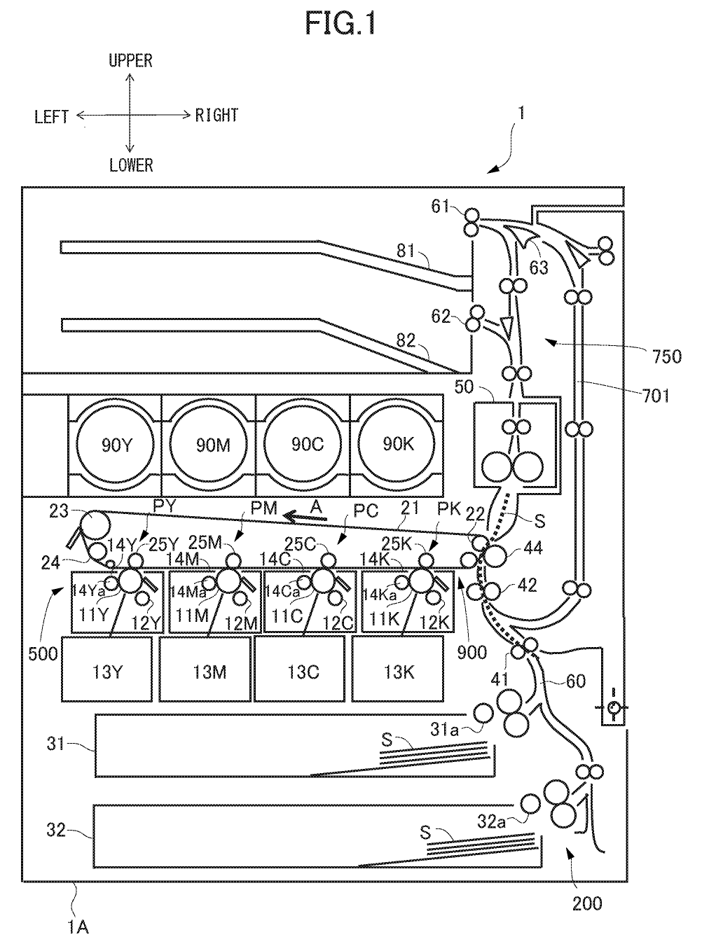

Hereinafter, this embodiment will be described. First, using FIG. 1, a schematic configuration of an image forming apparatus of this embodiment will be described. To be noted, in the following description, “front (obverse side)” and “rear (reverse side)” respectively refer to a front side and a rear side of the image forming apparatus, while “right” and “left” respectively correspond to directions when the apparatus is viewed from the front side. The front side of the apparatus refers to a side on which, for example, a liquid crystal display, keys, or switches are disposed, and a side from which process cartridges and cassettes, described below, are extracted from an apparatus body. “Vertical direction” refers to a vertical direction in a state in which the image forming apparatus is installed on an installation surface such as a floor. FIG. 1 illustrates the image forming apparatus 1 as viewed from the front side (obverse side).

The image forming apparatus 1 illustrated in FIG. 1 is a full color printer of an intermediate transfer system in which image forming units PY, PM, PC, and PK that form toner images of four colors: yellow (Y), magenta (M), cyan (C), and black (K) are disposed to face an intermediate transfer belt 21. The image forming apparatus 1 includes an image forming unit 500, and the image forming unit 500 forms the toner image on a recording material S based on an image signal received from a document reading apparatus, which reads an image on a document, or an external device such as a personal computer (not shown). The image forming unit 500 includes the image forming units PY, PM, PC, and PK, and an intermediate transfer belt unit 900.

A conveyance process of the recording material S in the image forming apparatus 1 will be described. The recording material S is stored in one or a plurality (here, two) of cassettes 31 and 32 in a stacked manner, and a supply unit 200 starts the conveyance of the recording material S. The supply unit 200 includes supply rollers 31a and 32a, and the recording material S is supplied one sheet at a time from either the cassette 31 or 32 to a conveyance path 60 by the supply rollers 31a and 32a in accordance with the timing of the image formation. In the image forming apparatus 1 of this embodiment, the conveyance path 60 is configured to convey the recording material S in an upward direction from below (so-called vertical conveyance system). To be noted, the recording material S includes various types of sheet materials, such as paper including standard paper, thick paper, rough paper, embossed paper, and coated paper, as well as a plastic film and cloth.

The recording material S supplied from the cassettes 31 and 32, serving as storage members, to the conveyance path 60 is conveyed to a pre-registration roller pair 41 disposed in the middle of the conveyance path 60. The pre-registration roller pair 41 corrects the skew of the recording material S. In particular, a leading edge of the recording material S conveyed by the pre-registration roller pair 41 abuts against a nip portion of a registration roller pair 42 which is in a stopped state; thereby, the recording material S forms a loop, and the skew of the recording material S is corrected. The intermediate transfer belt 21 is disposed above the registration roller pair 42, serving as a rotary member pair, and the registration roller pair 42 conveys the recording material S to a secondary transfer portion in an upward direction from below in accordance with a timing in which the toner image on the intermediate transfer belt 21 is transferred onto the recording material S. On an upstream side of the secondary transfer portion with respect to the conveyance direction (vertical direction) of the recording material S, the registration roller pair 42 is disposed at a position closest to the second transfer portion in the conveyance path 60. The secondary transfer portion is formed by a secondary transfer inner roller 22 and a secondary transfer outer roller 44, which are disposed to face each other across the intermediate transfer belt 21, and is a nip portion which, by applying a certain pressurizing force and a secondary transfer voltage, transfers the toner image from the intermediate transfer belt 21 onto the recording material S.

A formation process of the image, which is conveyed to the secondary transfer portion in a corresponding timing with respect to the conveyance process of the recording material S to the secondary transfer portion as described above, will be described. First, the image forming units PY to PK will be described. However, the image forming units PY to PK for each color are essentially the same except for the colors of toners; therefore, the image forming unit PY for yellow will be described as a representative.

The image forming unit PY includes a photosensitive drum 11Y, a charge roller 12Y, an exposing unit 13Y, and a developing unit 14Y. A surface of the rotating photosensitive drum 11Y is uniformly charged by the charge roller 12Y (image forming member) beforehand, and, thereafter, an electrostatic latent image is formed by a laser beam irradiated from the exposing unit 13Y which is driven based on the image signal. Then, the electrostatic latent image formed on the photosensitive drum 11Y is developed into the toner image by the developing unit 14Y. In the developing unit 14Y, a developing sleeve 14Ya (image forming member), which bears developer containing the toner and a carrier, rotates, and develops the electrostatic latent image into the toner image. To be noted, the toner is consumed in conjunction with the development; therefore, a toner bottle 90Y storing the toner for replenishment is rotatably driven at an appropriate timing, and the toner is replenished from the toner bottle 90Y to the developing unit 14Y.

A primary transfer voltage is applied to the toner image formed on the photosensitive drum 11Y by a primary transfer roller 25Y disposed to face the photosensitive drum 11Y across the intermediate transfer belt 21, and the toner image is primarily transferred from the photosensitive drum 11Y onto the intermediate transfer belt 21. Primary transfer residual toner remaining on the photosensitive drum 11Y after the primary transfer is removed by a photosensitive drum cleaner.

The intermediate transfer belt 21 is an endless belt that is tensioned by the secondary transfer inner roller 22, a drive roller 23, a tension roller 24, and the like, and is moved in an arrow A direction in FIG. 1. The image forming processes of each color performed in parallel by the image forming units PY to PK of each color are executed in synchronization with the timing at which the toner images of respective colors are sequentially superimposed on the toner image that has been primarily transferred onto the intermediate transfer belt 21 upstream in a movement direction. As a result, a full color toner image is ultimately formed on the intermediate transfer belt 21, and the toner image is conveyed to the secondary transfer portion by the movement of the intermediate transfer belt 21. To be noted, the primary transfer rollers 25Y to 25K, the intermediate transfer belt 21, the secondary transfer inner roller 22, the drive roller 23, and the tension roller 24 are integrally configured as the intermediate transfer belt unit 900.

As described above, through the conveyance process and the image forming process as respectively described, the timings of the recording material S and the full color toner image are aligned at the secondary transfer portion, and the toner image is secondarily transferred from the intermediate transfer belt 21 onto the recording material S. Secondary transfer residual toner remaining on the intermediate transfer belt 21 after passing through the secondary transfer portion is removed from the intermediate transfer belt 21 by a belt cleaner. The recording material S onto which the toner image has been transferred is conveyed to a fixing unit 50 in the conveyance path 60, and the toner image is fixed on the recording material S by applying heat and pressure in the fixing unit 50. The fixing unit 50 includes a fixing roller heated by a heater (not shown) and a pressurizing roller that comes into contact with the rotating fixing roller, and forms a fixing nip portion, and fixes the toner image on the recording material S by applying the heat and pressure with respect to the recording material S which passes through the fixing nip portion.

The recording material S on which the toner image has been fixed by the fixing unit 50 is conveyed further upward in the conveyance path 60, and discharged to the outside by a sheet discharge unit 750. The sheet discharge unit 750 includes sheet discharge rollers 61 and 62, and a flapper 63, and the recording material S is discharged by the sheet discharge rollers 61 and 62 and stacked on sheet discharge trays 81 and 82. In this embodiment, in a case where an operation mode is a duplex mode to form the toner image on both sides of the recording material S, so as to form the toner image on the other side of the recording material S on whose one side the image has been formed, the recording material S is conveyed to a duplex conveyance path 701. In the case of the duplex mode, the recording material S is conveyed by the forward rotation of the sheet discharge roller 61 until a trailing edge of the recording material S passes through the flapper 63; thereafter, the sheet discharge roller 61 is rotated in reverse to switch the leading and trailing edges, and the recording material S is conveyed to the duplex conveyance path 701. The recording material S which has been conveyed to the duplex conveyance path 701 is again returned to the registration roller pair 42. Subsequent conveyance process and an image forming process on the rear side are the same as in the case described above; therefore, description will be omitted herein. The recording material S on whose opposite side the image has been formed is discharged to the outside by the sheet discharge unit 750.

### Apparatus Body

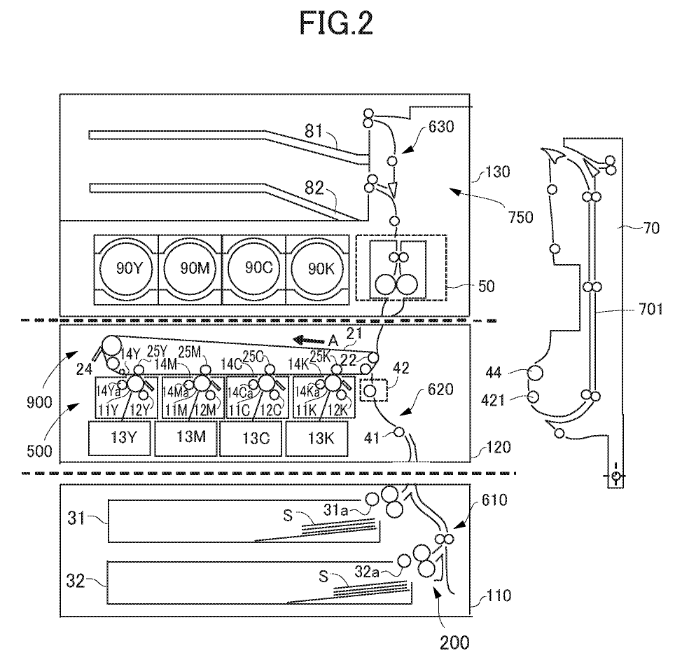

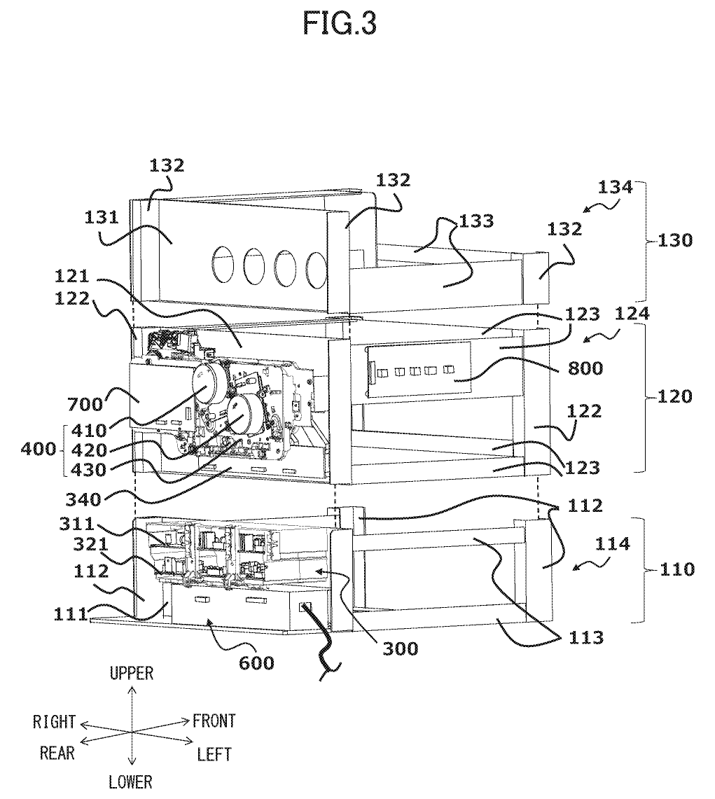

Next, with reference to FIG. 1, using FIGS. 2 to 3, the apparatus body 1A of the image forming apparatus 1 will be described. As illustrated in FIG. 2, the apparatus body 1A is divided into three separable structures (also referred to as modules): a supply block 110, an image forming block 120, and a discharge block 130. In this specification, the term “structure” refers to a configuration in which various units, power supply units, substrates, and the like are mounted on a frame body, described below, formed by combining numerous struts, stays (beams), sheet metals, and the like.

In this embodiment, the apparatus body 1A that achieves a sequence of functions for forming the toner image on the recording material S is configured such that the image forming block 120 is stacked on top of the supply block 110 and the discharge block 130 is stacked on top of the image forming block 120. While illustration is omitted, the supply and image forming blocks 110 and 120, and the image forming and discharge blocks 120 and 130 are connected by, for example, fastening metal plate members, which bridge between vertically positioned struts in a stacked state, using screws.

In addition, in this embodiment, a duplex conveyance block 70, which forms the duplex conveyance path 701, is provided in advance as a separate structure from the supply, image forming, and discharge blocks 110, 120, and 130. The duplex conveyance block 70 is pivotably mounted on the supply or image forming block 110 or 120 so as to straddle the image forming and discharge blocks 120 and 130. The duplex conveyance block 70 forms the conveyance path 60 (refer to FIG. 1) between itself and the image forming and discharge blocks 120 and 130. The conveyance path 60 is formed when the duplex conveyance block 70 is brought into a closed state, and is opened when the duplex conveyance block 70 is brought into an open state. Thereby, in a case where the recording material S is jammed in the conveyance path 60, a user can remove the recording material S jammed in the conveyance path 60 by opening the duplex conveyance block 70.

To open the conveyance path 60, one roller 421 of the registration roller pair 42, the secondary transfer outer roller 44, and one roller of each roller pair that conveys the recording material S in the conveyance path 60 are disposed in the duplex conveyance block 70. To be noted, the duplex conveyance block 70 is locked in the closed state by a lock mechanism (not shown) disposed in the discharge block 130 to prevent the conveyance path 60 from being automatically opened.

### Supply, Image Forming, and Discharge Blocks

As illustrated in FIG. 3, the supply, image forming, and discharge blocks 110, 120, and 130 respectively include a supply frame body 114, an image forming frame body 124, and a discharge frame body 134. These supply, image forming, and discharge frame bodies 114, 124, and 134 are each configured by a plurality of side panels including rear plates (111, 121, 131), a plurality of struts (112, 122, 132), a plurality of beams (113, 123, 133), and the like. In this embodiment, with respect to the vertical direction, the image forming frame body 124 is disposed adjacent to and on top of the supply frame body 114, and the discharge frame body 134 is disposed adjacent to and on top of the image forming frame body 124.

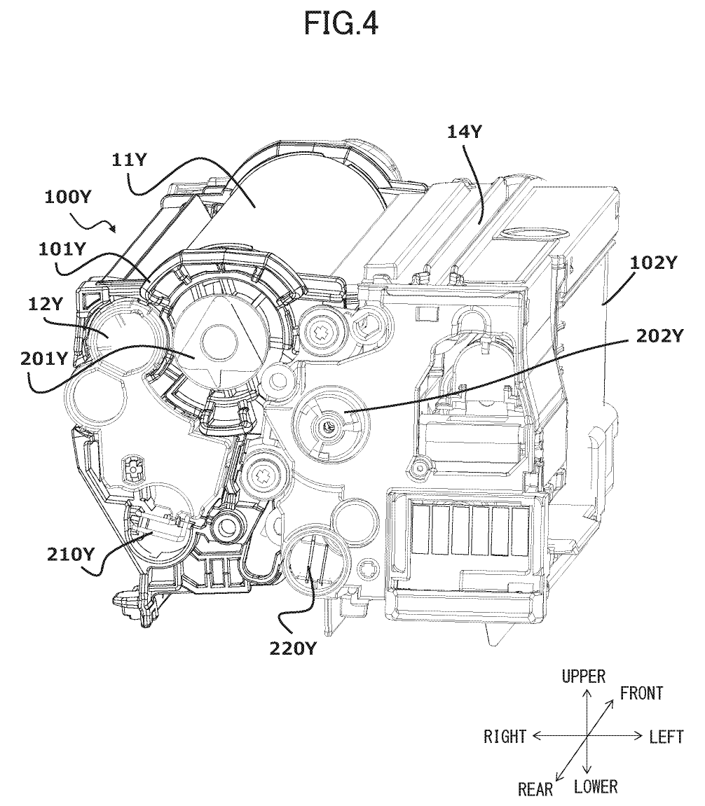

The supply block 110 is a structure in which components and units having a function of conveying the recording material S to the registration roller pair 42 are assembled on the supply frame body 114. The image forming block 120 is a structure in which components and units having functions up to the transfer of the toner image onto the recording material S are assembled on the image forming frame body 124. The discharge block 130 is a structure in which components and units having a function of fixing the toner image on the recording material S and a function of discharging the recording material S, on which the toner image has been fixed, to the sheet discharge trays 81 and 82 are assembled on the discharge frame body 134. In particular, the image forming unit 500, including the intermediate transfer belt unit 900, and an image forming conveyance portion 620 are assembled on the image forming frame body 124, serving as a first frame body. In addition, a rail member, not shown, is assembled on the image forming frame body 124 to support process cartridges (refer to FIG. 4), described below, in a manner allowing the insertion and removal of the process cartridges in the front-rear direction. The cassettes 31 and 32, the supply unit 200, and a supply conveyance portion 610 are assembled on the supply frame body 114. The fixing unit 50 and a discharge conveyance portion 630 are assembled on the discharge frame body 134. In addition, the toner bottles 90Y, 90M, 90C, and 90K are detachably assembled on the discharge frame body 134.

In this embodiment, the conveyance path 60 (refer to FIG. 1) that conveys the recording material S in the upward direction from below is formed by being respectively divided into the supply, image forming, and discharge blocks 110, 120, and 130. That is, the supply conveyance portion 610 forms a portion of the conveyance path 60 in the supply block 110, the image forming conveyance portion 620 forms a portion of the conveyance path 60 in the image forming block 120, and the discharge conveyance portion 630 forms a portion of the conveyance path 60 in the discharge block 130.

As illustrated in FIG. 3, on the supply frame body 114, serving as a second frame body, an image forming high voltage power supply unit 300, including a charging high voltage substrate 321 and a developing high voltage substrate 311, and a main power supply 600 that converts power from an external power source and supplies the power to the image forming high voltage power supply unit 300 are disposed. The image forming high voltage power supply unit 300, serving as a power supply unit (first power supply unit) is disposed on the supply rear plate 111 of the supply frame body 114 so as not to extend across a boundary between the image forming and supply frame bodies 124 and 114. In addition, the image forming high voltage power supply unit 300 is disposed so as not to overlap the main power supply 600 when viewed from a direction (front-back direction) perpendicular to the supply rear plate 111.

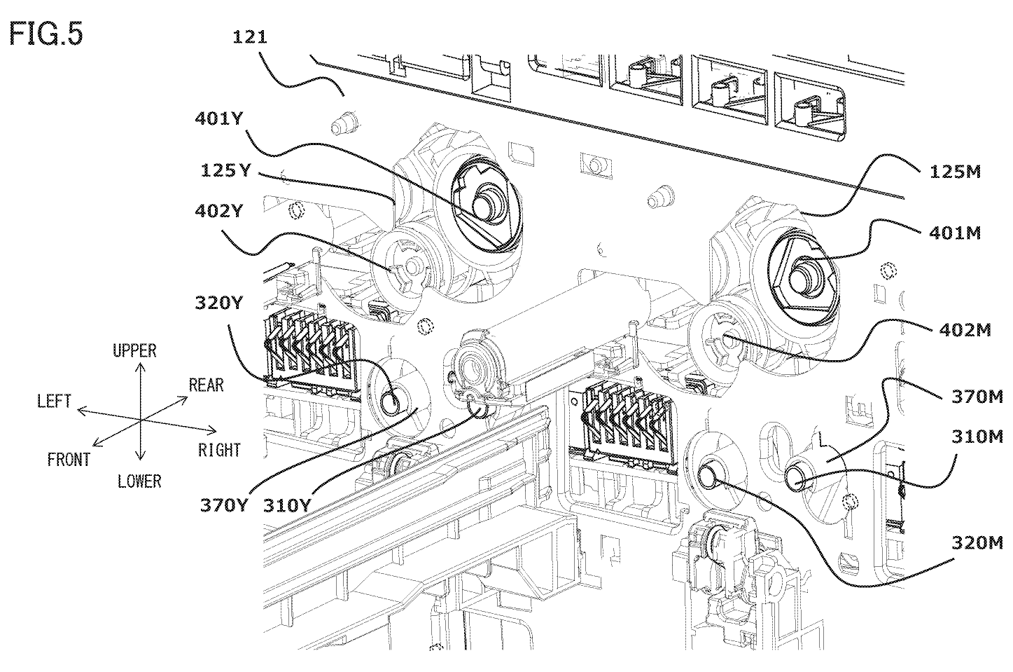

On the image forming frame body 124, a transfer high voltage substrate 800 (second power supply unit) for supplying power to the primary transfer rollers 25Y to 25K and the secondary transfer inner roller 22 is disposed on the left beam 123. In addition, an image forming drive unit 400 for driving the process cartridge 100Y (refer to FIG. 4) is disposed on the image forming rear plate 121. The image forming drive unit 400 drives, for example, the photosensitive drums 11Y to 11K, the charge rollers 12Y to 12K, the developing units 14Y to 14K (specifically, developing sleeves 14Ya to 14Ka), and the like. The image forming drive unit 400 and the image forming power supply unit 300 are respectively disposed on the image forming rear plate 121 (first side plate) and on the supply rear plate 111 (second side plate), which are disposed on the same rear side (one side in a certain direction). The image forming drive unit 400, serving as a driving unit, includes drive motors 410 and 420, and a driving unit casing 430 that supports these drive motors 410 and 420. A motor driving force of the drive motors 410 and 420 is drive-transmitted to a photosensitive member drive coupling 401Y and a developing drive coupling 402Y (refer to FIG. 5).

To be noted, in this embodiment, among image forming members constituting the image forming unit described above, first image forming members, to which the power is supplied from the image forming high voltage power supply unit 300, serving as a first power supply unit, include, for example, the charge roller 12Y, the developing sleeve 14Ya, and the like. In addition, second image forming members, to which the power is supplied from the transfer high voltage substrate 800, serving as the second power supply unit, include, for example, the primary transfer rollers 25Y to 25K, the secondary transfer inner roller 22, and the like. However, these first and second image forming members are not limited to this. For example, the primary transfer rollers 25Y to 25K and the secondary transfer inner roller 22 may be the first image forming members, and the charge roller 12Y and the developing sleeve 14Ya may be the second image forming members. In addition, among the members constituting the image forming unit, any member that is disposed on the first frame body and supplied with electric power may serve as either the first or second image forming member.

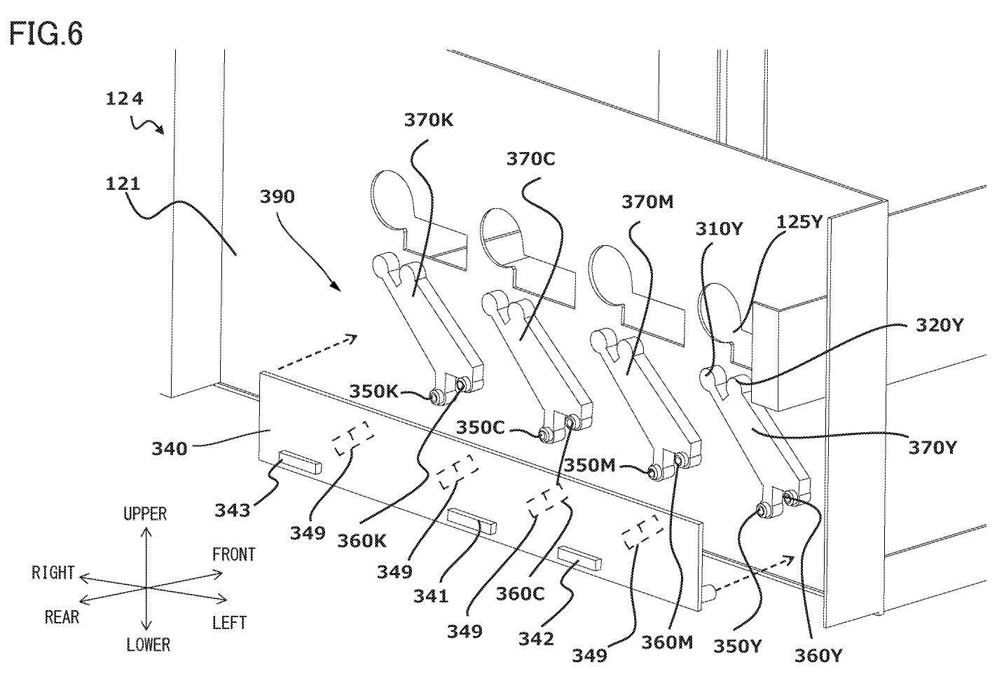

Further, a control substrate 700 and a relay substrate 340 are disposed on the image forming rear plate 121. The relay substrate 340 will be described below (refer to FIG. 6). The control substrate 700 includes an external interface (external I/F) for inputting/outputting signals to and from external devices, and executes various control processes in response to instructions from an operation panel unit or external devices (for example, a personal computer) connected through the external I/F. The control substrate 700 includes a central processing unit (CPU), a read only memory (ROM) for storing control programs, and a random access memory (RAM) for temporarily storing data. The CPU controls an overall operation of the image forming apparatus based on the control programs stored in the ROM. As an example, the CPU controls operations of the drive motors 410 and 420 of the image forming drive unit 400, the main power supply 600, at least the charging and developing high voltage substrates 321 and 311 of the image forming high voltage power supply unit 300, and the like.

As described above, the image forming apparatus 1 of this embodiment includes three structures: the supply, image forming, and discharge blocks 110, 120, and 130. These supply, image forming, and discharge blocks 110, 120, and 130 respectively include the supply, image forming, and discharge frame bodies 114, 124, and 134, and various units, power supply units, substrates, and the like are disposed on the frame body of each respective block. It is possible to assemble the apparatus body 1A by stacking the supply, image forming, and discharge frame bodies 114, 124, and 134 on which various units are mounted; therefore, it is possible to significantly reduce the number of assembly steps while improving the product quality of the apparatus body 1A. The main power supply 600 and the image forming high voltage power supply unit 300 are mounted on the supply frame body 114 after connecting the supply, image forming, and discharge frame bodies 114, 124, and 134.

### Process Cartridge

Next, using FIG. 4, the process cartridge will be described. FIG. 4 is a perspective view illustrating the process cartridge. In this embodiment, each process cartridge of yellow (Y), magenta (M), cyan (C), and black (K) is disposed in a removably insertable manner with respect to the image forming block 120. Since configurations of each process cartridge are identical, the process cartridge 100Y for yellow (Y) is illustrated in FIG. 4 as a representative. To be noted, since the configurations relating to the process cartridges other than yellow are identical to the configuration relating to the process cartridge 100Y for yellow, hereinafter, descriptions thereof will be omitted.

As illustrated in FIG. 4, the photosensitive drum 11Y, the charge roller 12Y, the developing unit 14Y, and the like are integrally assembled as a unit within the process cartridge 100Y. In the process cartridge 100Y, the photosensitive drum 11Y is rotatably supported by a photosensitive member housing 101Y, and a photosensitive member driven coupling 201Y is connected to a rear end portion of the photosensitive drum 11Y in a mounting direction of the process cartridge 100Y. The photosensitive drum 11Y is rotated by receiving a driving force from the image forming drive unit 400 via the photosensitive member driven coupling 201Y. In addition, in the photosensitive member housing 101Y, a cartridge charging contact 210Y for energizing the charge roller 12Y is disposed on a rear surface of the process cartridge 100Y, which is on the same side as the photosensitive member driven coupling 201Y.

In the process cartridge 100Y, the developing sleeve 14Ya of the developing unit 14Y is rotatably supported by a developing housing 102Y, and a developing driven coupling 202Y is connected to a rear end portion of the developing sleeve 14Ya. The developing sleeve 14Ya is rotated by receiving the driving force from the image forming drive unit 400 via the developing driven coupling 202Y. In addition, in the developing housing 102Y, a cartridge developing contact 220Y for energizing the developing sleeve 14Ya is disposed on the rear surface of the process cartridge 100Y, which is on the same side as the cartridge charging contact 210Y. The rear surface of the process cartridge 100Y is located on a downstream side in the mounting direction of the process cartridge 100Y, and is on a side that is connected to the image forming rear plate 121 of the image forming frame body 124.

In this embodiment, a conduction connection portion 390 is provided for enabling electrical conduction between the image forming high voltage power supply unit 300 (specifically, the charging and developing high voltage substrates 321 and 311) disposed on the supply frame body 114, and the process cartridge 100Y (specifically, the charge roller 12Y and the developing sleeve 14Ya) disposed on the image forming frame body 124 that is separable from the supply frame body 114. Hereinafter, using FIGS. 5 to 7, the conduction connection portion 390 according to the first embodiment will be described.

As illustrated in FIGS. 5 and 6, a positioning hole 125Y is formed in the image forming rear plate 121. The positioning hole 125Y is formed in a shape that allows the engagement of the photosensitive member housing 101Y of the process cartridge 100Y, and, when the photosensitive member housing 101Y engages with the positioning hole 125Y, the position of the process cartridge 100Y in the vertical and lateral directions is determined with respect to the image forming block 120.

The motor driving force of each of the drive motors 410 and 420 of the image forming drive unit 400 described above is respectively transmitted to the photosensitive member drive coupling 401Y and the developing drive coupling 402Y. The photosensitive member drive coupling 401Y engages with the photosensitive member driven coupling 201Y of the process cartridge 100Y, and inputs the driving force of the drive motor 410. Similarly, the developing drive coupling 402Y engages with the developing driven coupling 202Y of the process cartridge 100Y, and inputs the driving force of the drive motor 420.

As illustrated in FIG. 6, the conduction connection portion 390 includes a conduction guide portion 370Y (first member) and the relay substrate 340 (second member). The conduction guide portion 370Y and the relay substrate 340 are disposed on a rear surface of the image forming rear plate 121. A plurality of conduction guide portions (370Y to 370K) are disposed in parallel in the lateral direction so as to extend toward a side of the image forming high voltage power supply unit 300 (side of power supply unit). The relay substrate 340 is formed in an elongated shape in the lateral direction so as to overlap a portion of each of the plurality of conduction guide portions (370Y to 370K) when viewed in the front-rear direction.

As illustrated in FIG. 5, the conduction guide portion 370Y includes a charging conduction contact 310Y that establishes conduction with the cartridge charging contact 210Y of the process cartridge 100Y, and a developing conduction contact 320Y that establishes conduction with the cartridge developing contact 220Y of the process cartridge 100Y. These charging conduction contact 310Y, serving as a first contact, and developing conduction contact 320Y are formed by conductive elastic springs, and are exposed on a front surface of the image forming rear plate 121 so as to be capable of contacting the cartridge charging contact 210Y and cartridge developing contact 220Y in accordance with the mounting of the process cartridge 100Y. In addition, the conduction guide portion 370Y extends in the vertical direction, and as illustrated in FIG. 6, includes a charging high voltage contact 350Y and a developing high voltage contact 360Y formed of conductive elastic springs at a lower end portion. The charging conduction contact 310Y and the charging high voltage contact 350Y, as well as the developing conduction contact 320Y and the developing high voltage contact 360Y, are respectively in electrical connection.

Relay contacts 349 (second contacts) that respectively come into contact with the charging and developing high voltage contacts 350Y and 360Y are formed on a front surface of the relay substrate 340. A charging high voltage connector 342 and a developing high voltage connector 341 are formed on a rear surface of the relay substrate 340, and these charging and developing high voltage connectors 342 and 341 are respectively electrically connected to the charging and developing high voltage contacts 350Y and 360Y.

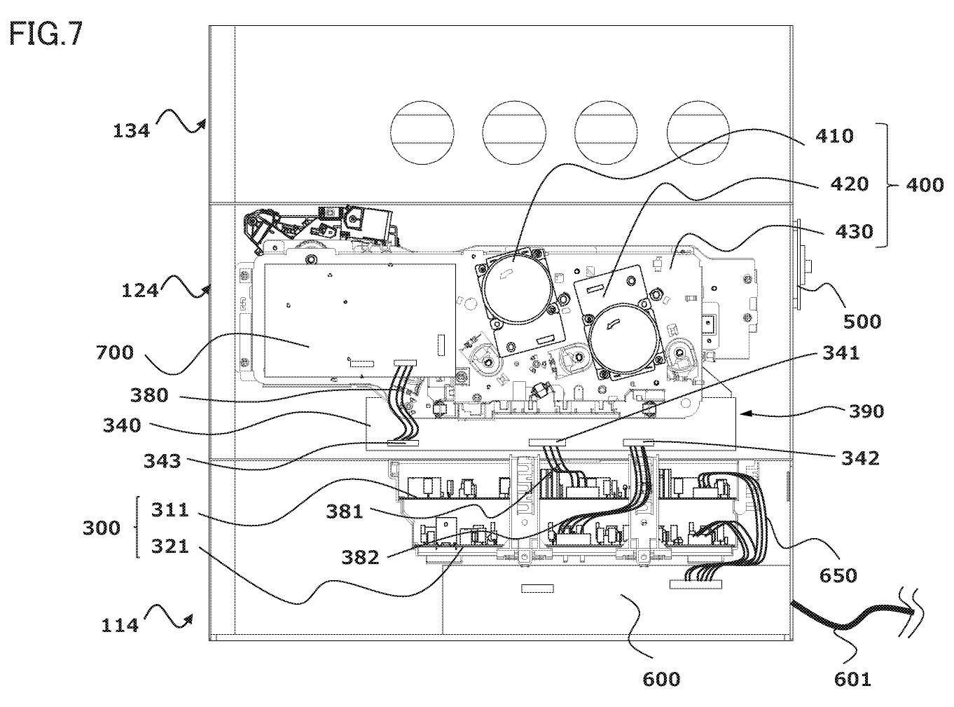

As illustrated in FIG. 7, the charging and developing high voltage substrates 321 and 311 are electrically connected to the main power supply 600 through a power wire bundle 650. Then, when the charging high voltage connector 342 of the relay substrate 340 and the charging high voltage substrate 321 are connected via a charging high voltage wire bundle 382, including a power cable, the relay substrate 340 and the charging high voltage substrate 321 are electrically connected. Similarly, when the developing high voltage connector 341 of the relay substrate 340 and the developing high voltage substrate 311 are connected via a developing high voltage wire bundle 381, including a power cable, the relay substrate 340 and the developing high voltage substrate 311 are electrically connected. As described above, in the state in which the supply and image forming frame bodies 114 and 124 are connected, the charging and developing high voltage substrates 321 and 311 of the image forming high voltage power supply unit 300, which are disposed on the supply frame body 114, are electrically connected to the charge roller 12Y and the developing sleeve 14Ya of the process cartridge 100Y, which is disposed on the image forming frame body 124, through the conduction connection portion 390.

To be noted, in the relay substrate 340, the charging and developing high voltage connectors 342 and 341 are disposed at positions below the image forming drive unit 400 so as not to overlap the image forming drive unit 400 when viewed in the front-rear direction. This is preferable because it becomes easier to connect the charging and developing high voltage wire bundles 382 and 381 to the charging and developing high voltage connectors 342 and 341 in the state in which the supply and image forming frame bodies 114 and 124 are connected.

In addition, a control signal connector 343 is disposed on the rear surface of the relay substrate 340, and, when the control signal connector 343 and the control substrate 700 are connected through a signal bundle 380, the control substrate 700 and the relay substrate 340 are electrically connected. As described above, the relay substrate 340 is connected to the charging and developing high voltage substrates 321 and 311 through the charging and developing high voltage wire bundles 382 and 381; therefore, the control signal of the control substrate 700 is also transmitted to the charging and developing high voltage substrate 321 and 311 through the relay substrate 340 and the signal bundle 380. That is, the control substrate 700 can control the charging and developing high voltage substrates 321 and 311 through the control signal.

As described above, in this embodiment, the process cartridge 100Y and the image forming drive unit 400 that drives the process cartridge 100Y are disposed on the image forming frame body 124, and the image forming high voltage power supply unit 300 that supplies the power to the process cartridge 100Y is disposed on the supply frame body 114. Then, the process cartridge 100Y and the image forming power supply unit 300, which are disposed on separate frame bodies, are electrically connected through the conduction connection portion 390. Thereby, it is possible to respectively dispose the image forming drive unit 400 and the image forming high voltage power supply unit 300 without increasing the size of the apparatus body 1A, which includes the supply and image forming frame bodies 114 and 124. In addition, in each of the supply and image forming frame bodies 114 and 124, it is possible to improve the assembly quality of the image forming drive unit 400 and the image forming high voltage power supply unit 300.

That is, the process cartridges 100Yto 100K disposed on the image forming frame body 124 occupy a major portion of the image forming frame body 124. Therefore, the image forming drive unit 400 that drives the process cartridges 100Yto 100Kalso occupies a major portion of an area of the image forming rear plate 121 of the image forming frame body 124. In such a case, even when attempting to mount the image forming high voltage power supply unit 300 on the same image forming rear plate 121 as the image forming drive unit 400, insufficient space is available for installation. To secure a mounting space for installing the image forming drive unit 400 on the image forming rear plate 121 of the image forming frame body 124, it is necessary to increase the size of the image forming frame body 124; as a result, the size of the apparatus body 1A is increased. In addition, if the image forming high voltage power supply unit 300 is disposed on the image forming rear plate 121 of the imaging frame body 124 so as to overlap with respect to the image forming drive unit 400 in the front-rear direction, it is not necessary to increase the size of the image forming frame body 124; however, such an arrangement reduces the ease of the replacement and maintenance of the image forming drive unit 400 and the image forming high voltage power supply unit 300. Therefore, in this embodiment, rather than disposing the image forming high voltage power supply unit 300 on the image forming frame body 124 in a manner avoiding the image forming drive unit 400, the image forming high voltage power supply unit 300 is mounted on the supply rear plate 111 of the supply frame body 114, which has a relatively greater surplus space.

### Second Embodiment

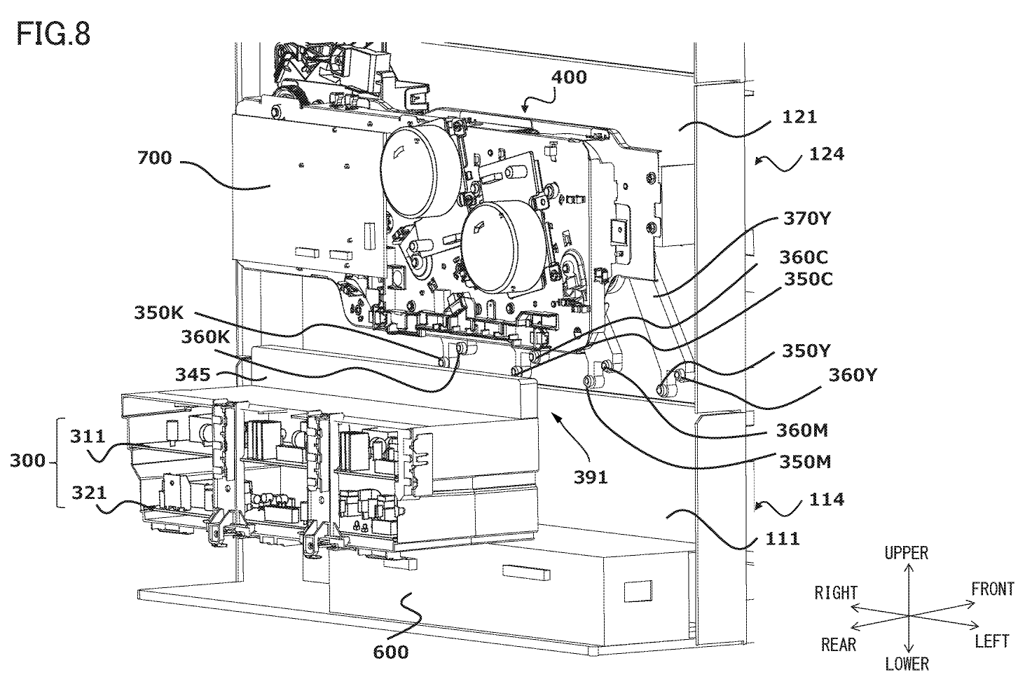

Next, with reference to FIG. 5, using FIGS. 8 to 10, a second embodiment will be described. To be noted, in FIGS. 8 to 10, configurations similar to those of the first embodiment will be denoted by the same reference characters, and descriptions thereof will be simplified or omitted.

As illustrated in FIG. 8, similar to the first embodiment described above, in the supply frame body 114, the main power supply 600 and the image forming high voltage power supply unit 300 are disposed on the supply rear plate 111. In addition, in the image forming frame body 124, the image forming drive unit 400 and the control substrate 700 are disposed on the image forming rear plate 121. Then, a conduction connection portion 391 is disposed to electrically connect the image forming high voltage power supply unit 300, which is disposed on the supply frame body 114, and the process cartridge 100Y, which is disposed on the image forming frame body 124. The conduction connection portion 391 according to the second embodiment is identical to the conduction connection portion 390 in that it includes the conduction guide portion 370Y, but differs from the conduction connection portion 390 in that it does not include the relay substrate 340. The conduction connection portion 391 includes the conduction guide portion 370Y (first member) and a power supply contact portion 345 (second member).

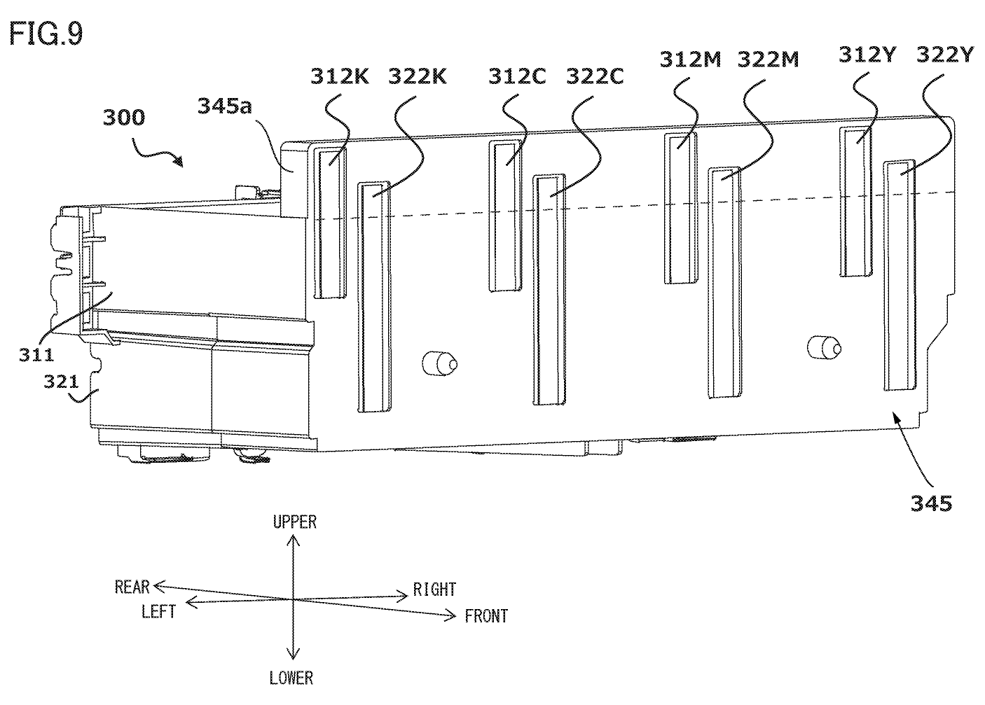

As illustrated in FIG. 9, the power supply contact portion 345 is integrally disposed with charging and developing high voltage substrates 321 and 311 on a front surface of the image forming high voltage supply unit 300. The power supply contact portion 345, serving as a second contact, includes a charging contact plate 322Y and a developing contact plate 312Y, which are electrically conductive. The power supply contact portion 345 includes a projection portion 345a projecting upward from the developing high voltage substrate 311, and the charging and developing contact plates 322Y and 312Y extend downward beneath the projection portion 345a. The charging and developing contact plates 322Y and 312Y are respectively electrically connected to the charging and developing high voltage substrates 321 and 311 disposed on a rear surface of the power supply contact portion 345.

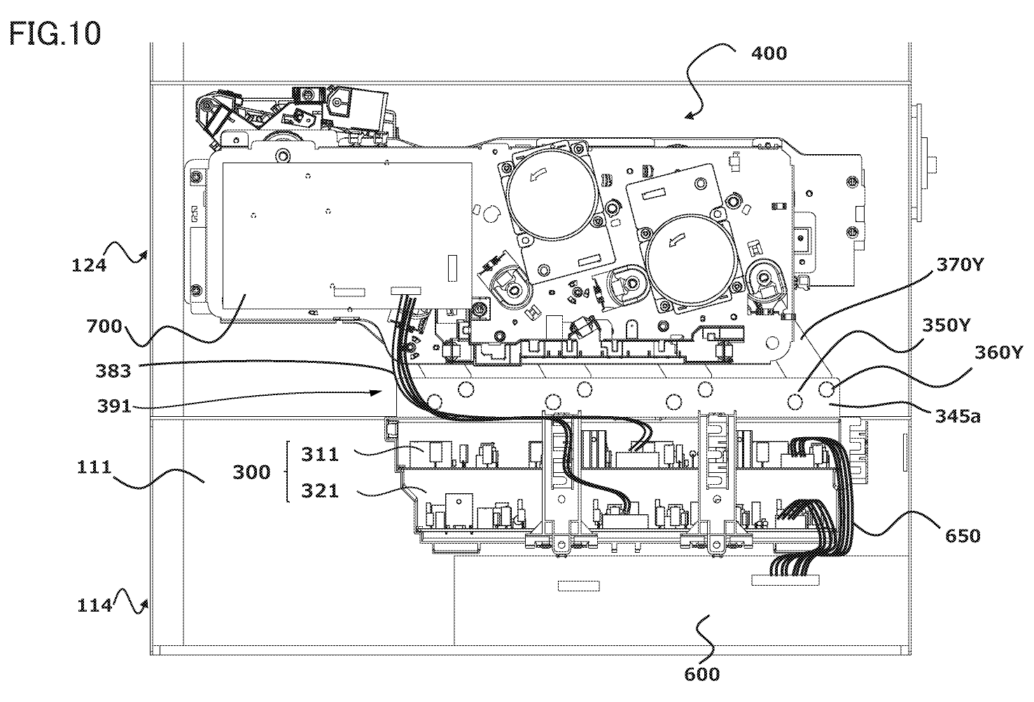

As illustrated in FIG. 10, in a state in which the image forming high voltage power supply unit 300 is disposed on the supply rear plate 111, the projection portion 345a of the power supply contact portion 345 projects upward beyond the supply frame body 114 so as to overlap a portion of the conduction guide portion 370Y disposed on the image forming frame body 124 when viewed in the front-rear direction. Then, the charging high voltage contact 350Y of the conduction guide portion 370Y comes into contact with the charging contact plate 322Y which is electrically connected to the charging high voltage substrate 321, and the developing high voltage contact 360Y of the conduction guide portion 370Y comes into contact with the developing contact plate 312Y which is electrically connected to the developing high voltage substrate 311. As described above, the power supply contact portion 345 is disposed on the image forming high voltage power supply unit 300 such that a portion of the power supply contact portion 345 projects from the image forming high voltage power supply unit 300, extends across the boundary between the image forming and supply frame bodies 124 and 114, and comes into contact with the charging and developing high voltage contacts 350Y and 360Y. However, when viewed in a direction (front-rear direction) perpendicular to the supply rear plate 111, within the power supply contact portion 345, an area of the projecting portion 345a which projects to extend across the boundary is equal to or less than 20% of the total area of the power supply contact portion 345.

As described above, in the state in which the supply and image forming frame bodies 114 and 124 are connected, the charging and developing high voltage substrates 321 and 311 of the image forming high voltage power supply unit 300 disposed on the supply frame body 114 are electrically connected to the charge roller 12Y and the developing sleeve 14Ya of the process cartridge 100Y disposed on the image forming frame body 124 through the conduction connection portion 391. In this case, in contrast to the conduction connection portion 390 described above (refer to FIG. 7), in the absence of wiring through the charging and developing high voltage wire bundles 382 and 381, the charging high voltage substrate 321 and the charge roller 12Y, as well as the developing high voltage substrate 311 and the developing sleeve 14Ya, are respectively electrically connected.

To be noted, in this embodiment, the control substrate 700 is connected to the charging and developing high voltage substrates 321 and 311 through a signal bundle 383. Therefore, the control signal of the control substrate 700 is transmitted to the charging and developing high voltage substrates 321 and 311 through the signal bundle 383.

As described above, also in the second embodiment, it is possible to respectively dispose the image forming drive unit 400 and the image forming high voltage power supply unit 300 without increasing the size of the apparatus body 1A, which includes the image forming and supply frame bodies 124 and 114. In addition, in each of the image forming and supply frame bodies 124 and 114, it is possible to improve the assembly quality of the image forming drive unit 400 and the image forming high voltage power supply unit 300. Further, in the case of the second embodiment, by merely installing the image forming high voltage power supply unit 300 onto the supply frame body 114, the image forming high voltage power supply unit 300 is electrically connected to the charging and developing high voltage contacts 350Y and 360Y, which are exposed from a lower side of the image forming drive unit 400; thereby, a need for separate wiring using a wire bundle is eliminated, and installation work efficiency is improved.

### Third Embodiment

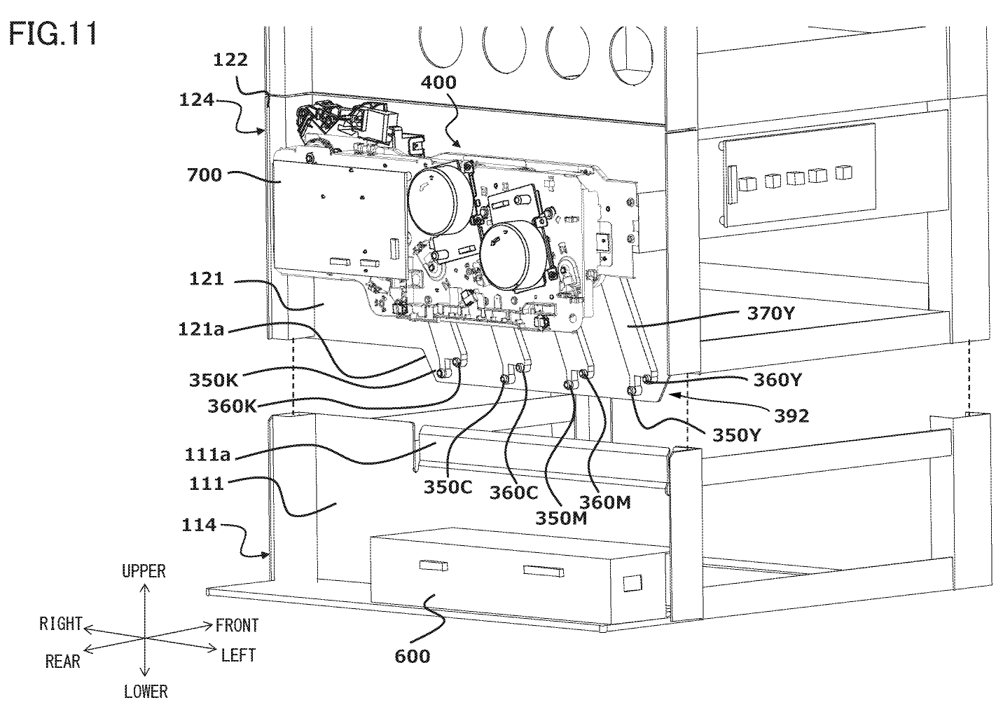

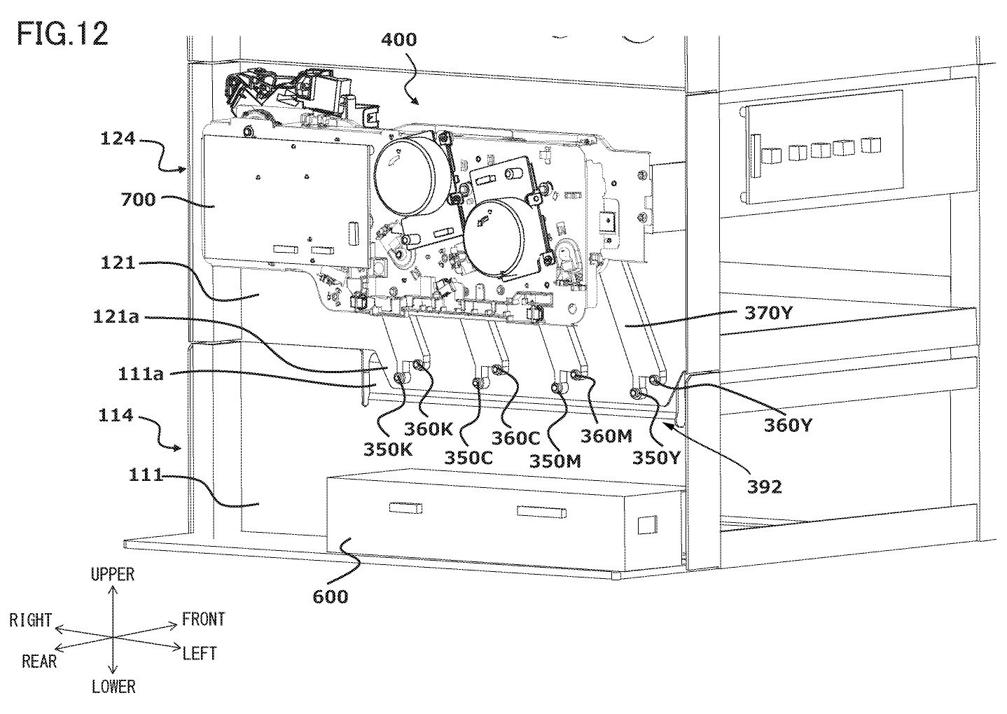

Next, with reference to FIG. 5, using FIGS. 11 to 14, a third embodiment will be described. To facilitate understanding of descriptions, the illustration of the image forming high voltage power supply unit 300 is omitted in FIGS. 11 and 12. To be noted, in FIGS. 11 to 14, configurations similar to those of the first embodiment described above will be denoted by the same reference characters, and descriptions thereof will be simplified or omitted.

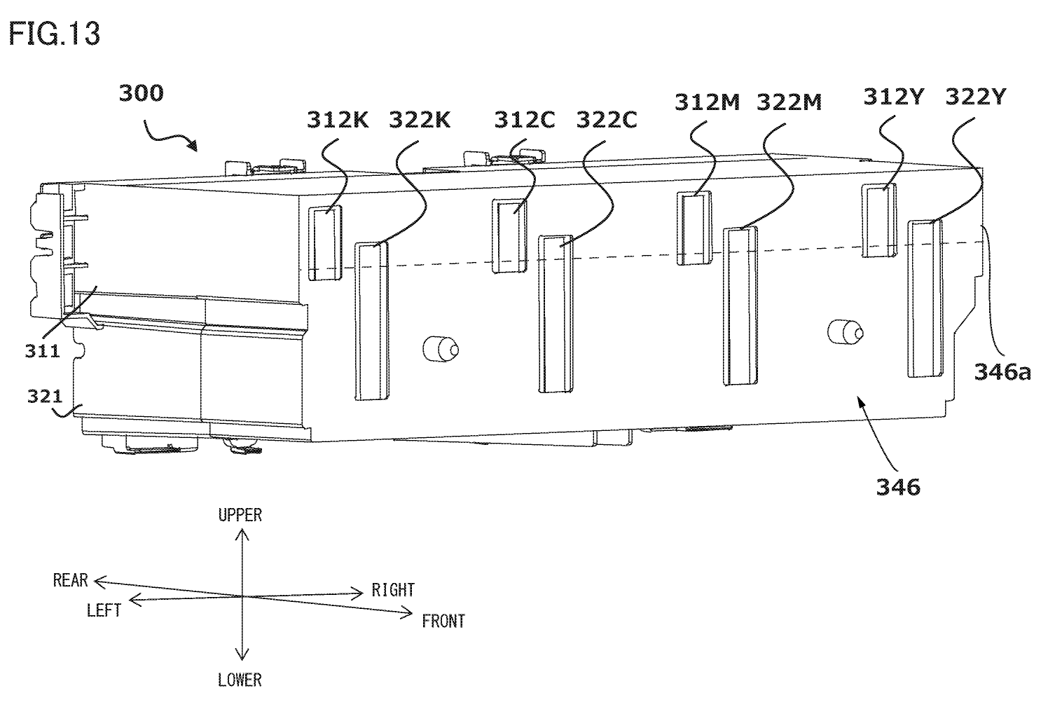

In the third embodiment, a conduction connection portion 392 is disposed to electrically connect the image forming high voltage power supply unit 300 disposed on the supply frame body 114 and the process cartridge 100Y disposed on the image forming frame body 124. The conduction connection portion 392 according to the third embodiment includes the conduction guide portion 370Y and a power supply contact portion 346 (refer to FIG. 13).

As illustrated in FIGS. 11 and 12, the image forming rear plate 121 of the image forming frame body 124 includes a projection portion 121a which projects downward from the image forming frame body 124 in the state in which the supply and image forming frame bodies 114 and 124 are connected. Then, the conduction guide portion 370Y is disposed on the image forming frame body 124 such that the charging and developing high voltage contacts 350Y and 360Y are positioned within the projection portion 121a when viewed in the front-rear direction. That is, the charging and developing high voltage contacts 350Y and 360Y project from the image forming frame body 124 to positions overlapping the supply frame body 114 when viewed in the front-rear direction.

As illustrated in FIG. 11, a guide portion 111a is formed on top of the supply rear plate 111 of the supply frame body 114 to guide the projection portion 121a of the image forming rear plate 121. As illustrated in FIG. 12, in the state in which the supply and image forming frame bodies 114 and 124 are connected, the projection portion 121a of the image forming rear plate 121 is positioned rearward of the guide portion 111a of the supply rear plate 111, and overlaps the guide portion 111a when viewed in the front-rear direction. As described above, the charging and developing high voltage contacts 350Y and 360Y are disposed within the projection portion 121a; thereby, the charging and developing high voltage contacts 350Y and 360Y are positioned at certain positions of the supply frame body 114. The certain positions of the supply frame 114 are positions at which the charging and developing high voltage contacts 350Y and 360Y come into contact with the charging and developing contact plates 322Y and 312Y of the power supply contact portion 346 illustrated in FIG. 13.

As illustrated in FIG. 13, the power supply contact portion 346 is integrally disposed with the charging and developing high voltage substrates 321 and 311 on the front surface of the image forming high voltage power supply unit 300. As can be understood when compared with the power supply contact portion 345 described above (refer to FIG. 9), the power supply contact portion 346 does not project upward beyond the developing high voltage substrate 311. The power supply contact portion 346 includes the charging and developing contact plates 322Y and 312Y, which are electrically conductive. In the state in which the image forming high voltage power supply unit 300 is disposed on the supply rear plate 111, these charging and developing contact plates 322Y and 312Y extend to a region 346a of the power supply contact portion 346 that overlaps the guide portion 111a of the supply rear plate 111 when viewed in the front-rear direction. The charging and developing contact plates 322Y and 312Y are respectively electrically connected to the charging and developing high voltage substrates 321 and 311 disposed on a rear surface of the power supply contact portion 346.

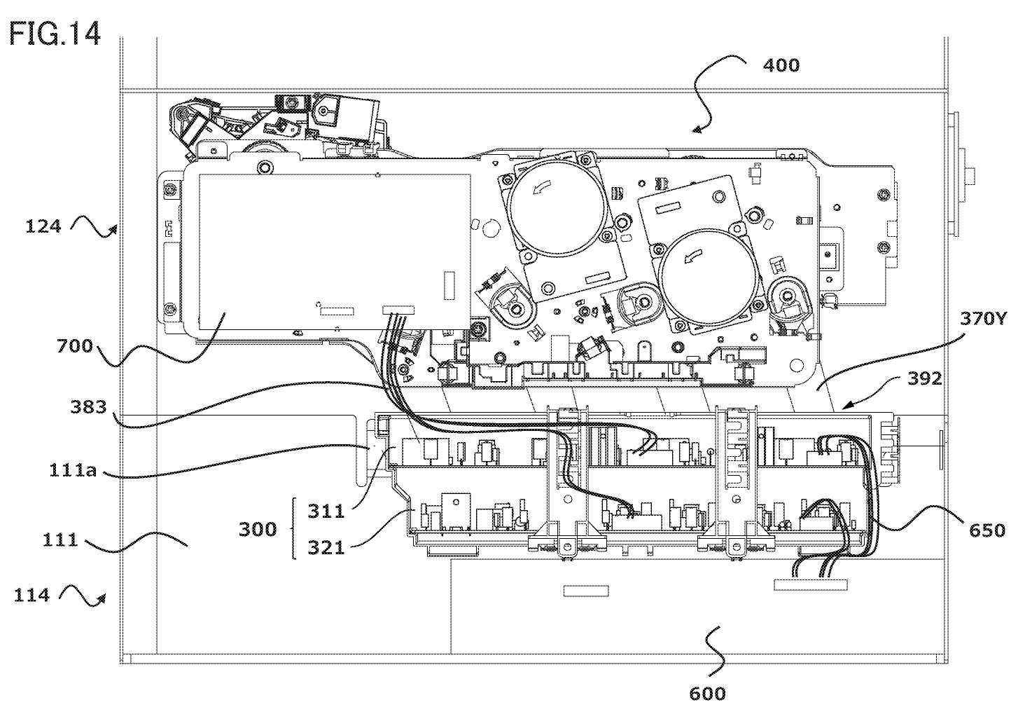

As illustrated in FIG. 14, the conduction guide portion 370Y projects downward below the image forming frame body 124 such that the charging and developing high voltage contacts 350Y and 360Y overlap the image forming high voltage power supply unit 300 (specifically, the region 346a of the power supply contact portion 346) disposed on the supply rear plate 111, when viewed in the front-rear direction. The charging high voltage contact 350Y of the conduction guide portion 370Y comes into contact with the charging contact plate 322Y that is electrically connected to the charging high voltage substrate 321, and the developing high voltage contact 360Y of the conduction guide portion 370Y comes into contact with the developing contact plate 312Y that is electrically connected to the developing high voltage substrate 311. As described above, in the state in which the supply and image forming frame bodies 114 and 124 are connected, the charging and developing high voltage substrates 321 and 311 of the image forming high voltage power supply unit 300 disposed on the supply frame body 114 are electrically connected to the charge roller 12Y and the developing sleeve 14Ya of the process cartridge 100Y disposed on the image forming frame body 124 via the conduction connection portion 392. In this case, similar to the conduction connection portion 391 described above (refer to FIG. 10), the charging high voltage substrate 321 and the charge roller 12Y, as well as the developing high voltage substrate 311 and the developing sleeve 14Ya, are respectively electrically connected without requiring wiring by the charging and developing high voltage wire bundles 382 and 381.

To be noted, in this embodiment, the control substrate 700 is connected to the charging and developing high voltage substrates 321 and 311 through the signal bundle 383. Therefore, the control signal of the control substrate 700 is transmitted to the charging and developing high voltage substrates 321 and 311 through the signal bundle 383.

As described above, also in the third embodiment, it is possible to respectively dispose the image forming drive unit 400 and the image forming high voltage power supply unit 300 without increasing the size of the apparatus body 1A, which includes the image forming and supply frame bodies 124 and 114. In addition, in each of the image forming and supply frame bodies 124 and 114, it is possible to improve the assembly quality of the image forming drive unit 400 and the image forming high voltage power supply unit 300. Further, in the third embodiment, by projecting the charging and developing high voltage contacts 350Y and 360Y toward the side of the supply frame body 114, it is possible to contribute to miniaturization by reducing the height of the image forming apparatus 1. That is, in the first and second embodiments described above, with respect to the vertical direction, the length of the image forming frame body 124 needs to be a length which is obtained by adding the length of the image forming drive unit 400 and the length of an exposed portion of the conduction guide portion 370Y exposed from below the image forming drive unit 400 (refer to FIG. 8), but in the third embodiment, the length is sufficient with that of the image forming drive unit 400. A portion of the exposed portion of the conduction guide portion 370Y, which includes the charging and developing high voltage contacts 350Y and 360Y, is overlapped on the side of the supply frame body 114 which possesses relatively surplus space; thereby, it is possible to reduce the height of the image forming apparatus 1.

### Fourth Embodiment

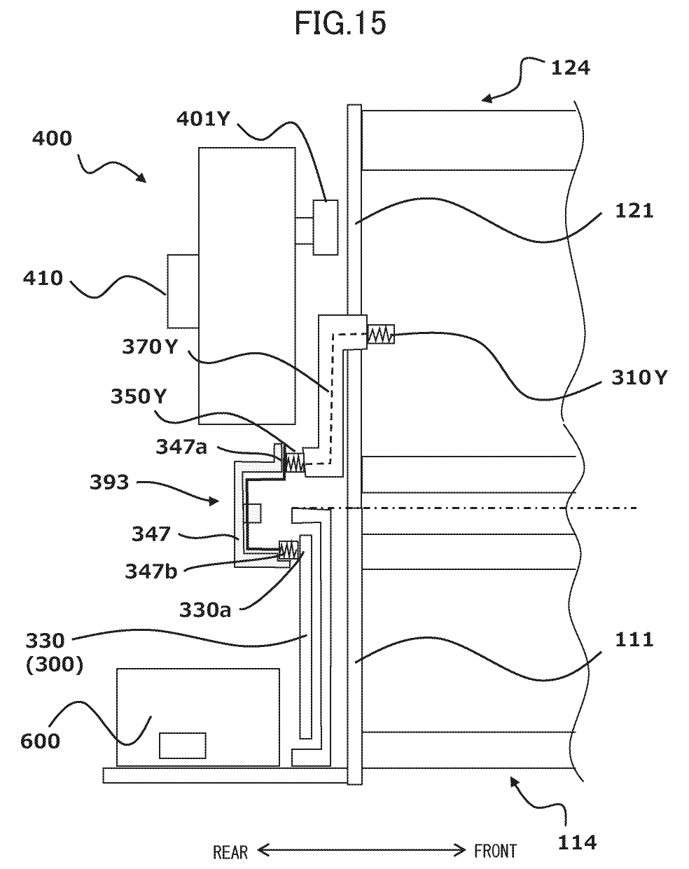

Next, using FIG. 15, a fourth embodiment will be described. The image forming high voltage power supply unit 300 of this embodiment includes a single charging/developing high voltage substrate 330 that combines the charging and developing high voltage substrates 321 and 311 described above. Hereinafter, an electrical connection configuration between the charging/developing high voltage substrate 330 and the charge roller 12Y will be described as an example, and, since an electrical connection configuration between the charging/developing high voltage substrate 330 and the developing sleeve 14Ya is similar, description thereof will be omitted. To be noted, in FIG. 15, configurations similar to those of the first embodiment described above will be denoted by the same reference characters, and descriptions thereof will be simplified or omitted.

As illustrated in FIG. 15, the charging/developing high voltage substrate 330 is disposed on the supply rear plate 111 of the supply frame body 114. The charging/developing high voltage substrate 330 is capable of adjusting and outputting a voltage value to be supplied to the charge roller 12Y in accordance with the control signal from the control substrate 700. A contact portion 330a is formed on the charging/developing high voltage substrate 330. Then, a conduction connection portion 393 is disposed for electrically connecting the charging/developing high voltage substrate 330 disposed on the supply frame body 114 and the process cartridge 100Y (specifically, the charge roller 12Y) disposed on the image forming frame body 124.

The conduction connection portion 393 according to the fourth embodiment includes the conduction guide portion 370Y (first member) and a relay guide portion 347 (second member). The plurality of conduction guide portions (370Y to 370K) are arranged in the lateral direction on the image forming rear plate 121 (refer to FIG. 6). As described above, the conduction guide portion 370Y includes the charging conduction contact 310Y and the charging high voltage contact 350Y formed of conductive elastic springs, and the charging conduction contact 310Y and the charging high voltage contact 350Y are electrically connected.

The relay guide portion 347 is formed in an elongated shape in the lateral direction so as to overlap a portion of each of the plurality of conduction guide portions (370Y to 370K) when viewed in the front-rear direction. The relay guide portion 347 includes conductive contact portions 347a and contact portions 347b formed of conductive elastic springs, and the contact portions 347a and the contact portions 347b are electrically connected. The relay guide portion 347 is bridged between the conduction guide portion 370Y and the charging/developing high voltage substrate 330 by extending across the boundary between the image forming and supply frame bodies 124 and 114 such that the contact portion 347a comes into contact with the charging high voltage contact 350Y of the conduction guide portion 370Y and the contact portion 347b (second contact) comes into contact with the contact portion 330a of the charging/developing high voltage substrate 330.

As described above, in the state in which the supply and image forming frame bodies 114 and 124 are connected, the charging/developing high voltage substrate 330 disposed on the supply frame body 114 and the charge roller 12Y of the process cartridge 100Y disposed on the image forming frame body 124 are electrically connected by the conduction connection portion 393. In this case, similarly to the conduction connection portions 391 and 392 described above (refer to FIGS. 10 and 14), the charging/developing high voltage substrate 330 and the charge roller 12Y are electrically connected without requiring wiring by the charging high voltage wire bundle 382.

As described above, also in the fourth embodiment, the image forming drive unit 400 and the image forming high voltage power supply unit 300 (charging/developing high voltage substrate 330) can be respectively disposed without increasing the size of the apparatus main body 1A, which includes the image forming and supply frame bodies 124 and 114. In addition, in each of the image forming and supply frame bodies 124 and 114, the assembly quality of the image forming drive unit 400 and the image forming high voltage power supply unit 300 can be improved. Further, in the case of the fourth embodiment, by merely installing the relay guide portion 347, the image forming high voltage power supply unit 300 is electrically connected to the charging and developing high voltage contacts 350Y and 360Y; thereby, the assembly operation is streamlined.

### Other Embodiments

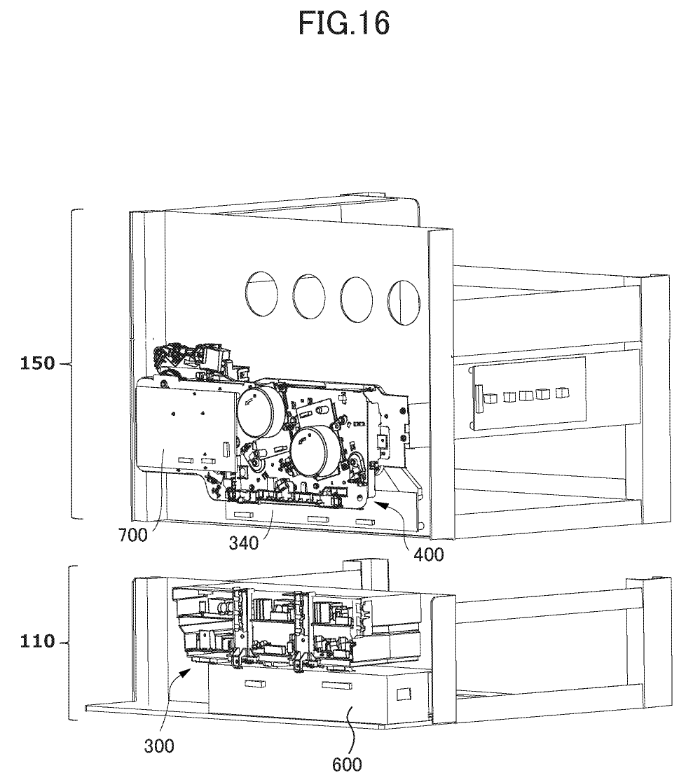

To be noted, in the first to fourth embodiments described above, the image forming apparatus 1 includes three separable structures: the supply block 110, the image forming block 120, and the discharge block 130 (refer to FIG. 3); however, it is not limited to this. For example, the conduction connection portions 390 to 393 described above may also be applied to an image forming apparatus having a structure separable into two blocks: the supply block 110 and an image forming/discharge block 150 illustrated in FIG. 16. To be noted, the image forming/discharge block 150 is a structure in which the image forming block 120 and the discharge block 130 described above are integrated into a single frame body.

To be noted, in the first to fourth embodiments described above, the case where the image forming high voltage power supply unit 300 is disposed on the supply frame body 114 (refer to FIG. 3); however, it is not limited to this. The conduction connection portions 390 to 393 described above may also be applied to an image forming apparatus in which the process cartridges are disposed on the imaging frame body 124 and the image forming high voltage power supply unit 300 is disposed on the discharge frame body 134.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-041797, filed March 14, 2025 which is hereby incorporated by reference herein in its entirety.

What is claimed is:

1. An image forming apparatus configured to form an image on a recording material, the image forming apparatus comprising:
a first frame body;
a second frame body disposed adjacent to the first frame body;
an image forming member disposed on the first frame body;
a driving unit disposed on the first frame body and configured to drive the image forming member;
a power supply unit disposed on the second frame body and configured to supply power to the image forming member; and
a conduction connection portion configured to electrically connect the image forming member and the power supply unit,
wherein the conduction connection portion includes:
a first member disposed on the first frame body and including a first contact that is connected to the image forming member, the first member extending toward a side of the power supply unit; and
a second member including a second contact that is electrically connected to the first member, the second member being configured to electrically connect the power supply unit and the first member.

2. The image forming apparatus according to claim 1,
wherein the power supply unit is disposed on the second frame body so as not to extend across a boundary between the first frame body and the second frame body.

3. The image forming apparatus according to claim 1,
wherein the driving unit is mounted on a first side plate disposed on one side of the first frame body in a certain direction, and
wherein the power supply unit is mounted on a second side plate disposed on the one side of the second frame body in the certain direction.

4. The image forming apparatus according to claim 1,
wherein the first frame body is disposed on top of the second frame body with respect to a vertical direction.

5. The image forming apparatus according to claim 1,
wherein the second member is a relay substrate disposed on the first frame body.

6. The image forming apparatus according to claim 5,
wherein the relay substrate is connected to the power supply unit through a wire bundle.

7. The image forming apparatus according to claim 2,
wherein the second member is disposed on the second frame body and is electrically connected to the first member by extending across the boundary with the first frame body.

8. The image forming apparatus according to claim 2,
wherein the first member is electrically connected to the second member by extending across the boundary with the second frame body.

9. The image forming apparatus according to claim 1,
further comprising a control substrate that is disposed on the first frame body and is configured to control an overall operation of the image forming apparatus.

10. The image forming apparatus according to claim 4,
further comprising a storage member that is disposed in the second frame body and is configured to store the recording material.

11. The image forming apparatus according to claim 1,
wherein the power supply unit is a first power supply unit, and
wherein the image forming member is a first image forming member,
the image forming apparatus further comprising:
a second image forming member that is disposed on the first frame body and differs from the first image forming member; and
a second power supply unit that is disposed on the first frame body and is configured to supply power to the second image forming member.
